(19) United States
(12) Patent Application Publication
(10) Pub. No.: US 2011/0143134 A1
(43) Pub. Date: Jun. 16, 2011

(54) RELEASE MATERIALS

(75) Inventors: Jeffrey O. Emslander, Afton, MN (US); Geroge J. Clements, Afton, MN (US)

(73) Assignee: 3M INNOVATIVE PROPERTIES COMPANY, Saint Paul, MN (US)

(21) Appl. No.: 13/059,255

(22) PCT Filed: Aug. 19, 2009
(86) PCT No.: PCT/US2009/054322

§ 371 Date: Feb. 16, 2011

Related U.S. Application Data
(60) Provisional application No. 61/089,993, filed on Aug. 19, 2008.

(51) Int. Cl. B32B 33/00; B29C 59/00

(52) U.S. Cl. 428/352; 264/293

(57) ABSTRACT

The present application is directed to an adhesive article comprising a pressure sensitive adhesive layer and a release layer in contact with the pressure sensitive adhesive layer. The release layer comprises a polyolefin block copolymer. Generally, the polyolefin block copolymer has a density of no greater than 0.9 g/cc.

### TECHNICAL FIELD

This invention relates to release materials. For example, materials useful as a release liner for pressure sensitive adhesive tapes.

### BACKGROUND

Release surfaces are well known, for example in the pressure sensitive adhesive tape industry to provide a release surface so that a tape can be unwound from a roll without the adhesive sticking to the backside of the tape. The release coating can also be coated onto a liner which serves as a carrier for a pressure sensitive adhesive transfer tape or a double coated tape, both of which are tacky on both sides of the tape. Release surfaces are also useful as a release liner for use with pressure sensitive adhesive films.

Materials commonly used for release surfaces and coatings are silicone compositions because they can be formulated to provide varying levels of release from a “premium” release (i.e., the force to unwind the tape is very low) to a “low adhesion backsize” release which typically requires a greater force to unwind.

The primary deficiency of silicone release coatings is the potential contamination that may be associated with them. When workers handle a silicone release coated tape or liner, silicone can transfer to their hands, work gloves, or clothing. The silicone can be further transferred from their hands to surfaces to be painted, and cause problems such as poor adhesion of the paint to the contaminated surface, and nonwetting of the paint in areas where the silicone is present on the surface. Additionally, electronics manufacturers generally avoid silicone in order to avoid contamination during the manufacturing process. Silicone release materials also tend to be costly, and silicone coated materials may be difficult to recycle. Additionally, generally silicone coating requires an additional processing step, for example it is generally coated in a second step on an existing substrate. This leads to additional costs in manufacturing.

Polyethylene has also been used as a release material and can be coated onto Kraft papers for a release liner or it can be used as a single layer film, or a multi-layer film with polyethylene co-extruded with or laminated to a base layer such as high density polyethylene, and the like. Higher density polyethylenes are limited in use to certain adhesives and are found to be unsuitable for very aggressive pressure sensitive adhesives because the adhesion between the polyethylene and the adhesive is so high that it can be difficult to start removing the liner. Since the release force is high, the adhesive and/or the liner can also be damaged as one tries to separate the adhesive from the liner.

Some polyolefin polymers and random polyolefin copolymers have also been used as release materials. Additionally, these copolymers have been blended with polyethylene. The addition of polyethylene to these polyolefin copolymers has led to increased, and undesirable, release values. There remains an ongoing need for controlled release liners for pressure sensitive adhesives that do not have a silicone release layer.

### SUMMARY

The present application is directed to an adhesive article comprising a pressure sensitive adhesive layer and a release layer in contact with the pressure sensitive adhesive layer. The release layer comprises a polyolefin block copolymer. Generally, the polyolefin block copolymer has a density of no greater than 0.9 g/cc.

### DETAILED DESCRIPTION

In the present application, the materials useful for the release layer are olefinic block copolymers. Suitable alpha-olefins include butene-1, hexene-1, octene-1, and combinations thereof. Generally, copolymers of ethylene and octene-1 are used as release layers, for example with acrylate-based pressure sensitive adhesives. The copolymers are generically described as olefinic block copolymers. Generally, the copolymers have a density no greater than 0.90 grams per cubic centimeter (g/cc). Specific copolymers have a density of no greater than 0.89 g/cc, for example no greater than 0.88 g/cc. In some embodiments, the copolymer has a density of greater than 0.85 g/cc, for example greater than 0.86 g/cc. Such olefinic block copolymers additionally result in a reduction in static buildup and discharge in articles where the olefinic block copolymers are placed adjacent a pressure sensitive adhesive.

The copolymer generally has a high melting point. Some copolymers have a melting point of about 118 C to about 122 C, for example about 120 C.

Lower density copolymers are found to provide a lower release value, and values can be changed by blending copolymers of varying types. Suitable copolymers are commercially available from Dow Chemical Company, Midland, Mich., under the INFUSE tradename.

The release layer may comprise 100% of the copolymer. In other embodiments, the release layer comprises a blend of the copolymer with additional polymers. In some embodiments, the release layer comprises at least 10% by weight of the copolymer, for example 20%, 50% by weight of the copolymer. Suitable polymers useful in a blend with the copolymer include non-block polyolefin copolymers, such as those commercially available from Exxon under the EXACT tradename. Other useful polymers for the blend include silicone copolymers such as polydiorganosiloxane polyoxamide block copolymer as described in U.S. Patent Application Number 2007-0148474 and silicone polyurea polymers such as those described in U.S. Pat. No. 6,919,405, incorporated by reference herein.

As used herein, the terms release liner, liner, and release films will be used interchangeably. The release layer described herein is part of a release film. The release film can be prepared by extruding the copolymers as a single self supporting film where there is no second layer present. The film thickness may range from about 0.1 millimeter to about 0.4 millimeters, although the thickness will generally depend upon considerations such as the strength needed in the release liner, ease of handling the film, flexibility needed for the liner, and the like.

The release film may also be prepared by extruding the copolymer onto a base material, or by co-extruding the copolymer with one or more other polymers to form multi-layer films to provide additional strength and/or stiffness. Examples of suitable base materials include cellulosic materials such as paper, woven nonwoven fabrics, films such as nylon, polyester, polyolefins, acrylonitrile butadiene styrene, and sheet materials made of materials such as metal, ceramic, or plastic. The copolymer film can also be attached to the base material using an appropriate laminating adhesive. The base material can also be a sheet material suitable for thermoforming or vacuum forming so that trays can be formed having a release surface for holding pressure sensitive adhesive coated parts.

The thickness of the copolymer film on a base layer should be sufficient to provide the desired release force, and may be less than for a self-supporting sheet.

The films are typically extruded using a blown film process or a cast film process onto chill rolls having various surfaces such as a matte finish or a smooth finish to provide matte or glossy surfaces on the release liner. The film may then be structured as detailed below. Chill rolls can be treated or coated with materials to prevent sticking of the extrudate to the roll surface, such as Teflon or a plasma coating. Silicone rubber rolls may also be used for this purpose. The extruded films can also be extruded between a chill roll and a smooth polyester film to provide a glossy surface on one side and a matte surface on the other side, or between two polyester liners for two glossy surfaces. Additionally, cast film processes may include orientation steps such as a tenter process.

Multi-layer films may be prepared by known co-extrusion processes. Other polymers that can be co-extruded with the copolymer include polyolefins such as polypropylene, polyethylene, polybutylene, and mixtures thereof, nylon materials and polyesters. Co-extrusion with polyolefins is especially useful for making recyclable or re-usable liners.

In a multi-layer film construction, the polymers and co-polymers can be selected to exhibit differential release, i.e., the pressure sensitive adhesive will release from one side with a noticeably lower force than from the other side.

In a typical process to make pressure sensitive adhesive transfer tapes, an adhesive composition is coated onto a release liner. The adhesive is then cured to form a gelled film on the liner, and the release liner with the adhesive is rolled up into a large roll. Alternatively, the adhesive may be coated and cured on one liner, and then transferred onto a different liner before converting. In some embodiments, the adhesive does not require any curing after coating. The adhesive coated sheet is then converted into narrow rolls by slitting the large roll and winding the narrow width tape onto cores for customer use.

In another embodiment, the release liner is useful on a large format film, such as a graphic film. A variety of substrates are used graphic film for advertising and promotional displays. The substrate may comprise a polymeric sheet material such as an acrylic-containing film, a poly(vinyl chloride)-containing film, a poly(vinyl fluoride)-containing film, a urethane-containing film, a melamine-containing film, a polyvinyl butyral-containing film, a polyolefin-containing film, a polyester-containing film and a polycarbonate-containing film. For graphic films, it is desirable to have a film that accommodates curves, depressions or projections on a substrate surface so that the film may be stretched around curves or projections, or may be pressed down into depressions without breaking or delaminating the film (conformability). It is also desirable to have a film that can be applied over irregular and/or uneven surfaces without subsequent delaminating or releasing from the substrate surface (popping-up). In addition, it is desirable that graphic films are imageable (i.e. have a receptive surface for printing and/or graphics) and exhibit good weathering for outdoor applications. An adhesive layer is on the graphic film and the release liner is on the adhesive opposite the graphic film.

Examples of adhesives include pressure sensitive adhesives, hot melt or heat activated adhesives that are the pressure sensitive at the time of application such as pressure sensitive adhesives and any other type of PSA disclosed in Handbook of Pressure-Sensitive Adhesives, Ed. D. Satas, 2^{nd} Edition, Von Nostrand Reinhold, N.Y., 1989. Acrylate-based PSA's which are particularly useful in the present include those described in U.S. Pat. No. 4,181,752 (Clemens et al) and U.S. Pat. No. 4,418,120 (Kealy et al), WO 95/13331 and in Handbook of Pressure-Sensitive Adhesives, Ed. D. Satas, 2^{nd} Edition.

Generally, the adhesive layer has a peel strength from the release liner, for example a 180° peel strength at 90 inches/min of less than 30 grams/inch for “premium release” as may be required for films requiring a release liner. Generally, other uses require a higher than 30 g/inch release. For example, a low adhesion backsize for a tape. Other embodiments require a low release value, for example under 20 g/inch.

In some embodiments, the adhesive is a (meth)acrylic adhesive, comprising a (meth) acrylic acid esters and a reinforcing comonomer. Suitable acrylic acid ester monomers include 2-ethylhexyl acrylate, isooctyl acrylate, isononyl acrylate, n-butyl acrylate, decyl acrylate, dodecyl acrylate, and mixtures thereof. Preferred monomers include isooctyl acrylate, n-butyl acrylate, octadecyl acrylate, and mixtures thereof.

Useful reinforcing comonomers include acrylic acid, methacrylic acid, itaconic acid, acrylamide, substituted acrylamides, N-vinyl pyrrolidone. N-vinyl caprolactam, isobornyl acrylate, vinyl acetate, and cyclohexyl acrylate. Preferred comonomers include N-vinyl caprolactam, substituted acrylamides such as N,N-dimethylacrylamide, and isobutyl acrylate.

Suitable initiators are used to make pressure adhesives in the practice of the invention. The types and amounts initiators are used in amounts suitable to effect the type of polymerization used, e.g., phototinitiators such as benzyl dimethyl ketal can be used in amounts from about 0.1 to about 5 parts per hundred parts of monomer for ultraviolet light photopolymerized adhesives, and 2,2′- azobis(isobutryonitrile) may be used for solvent polymerization in amounts of from about 0.1 parts to about 2 parts per hundred parts of monomer.

The pressure sensitive adhesives may also include additives such as cross-linking agents, tackifiers, plasticizers, fillers, gases, blowing agents, glass or polymeric microspheres, silica, calcium carbonate fibers, surfactants, and the like. The additives are included in amounts sufficient to effect the desired properties.

The pressure sensitive adhesives may also contain thermosettable resins such as epoxies and urethanes, which can be heat cured after the pressure sensitive adhesive tape has been applied to a surface to form a thermosetting adhesive.

The pressure sensitive adhesives may be prepared by methods that are known in the industry, including solvent polymerization, radiation polymerization by such means as electron beam, gamma radiation, and ultraviolet radiation, emulsion polymerization, and the like. Methods of making pressure sensitive adhesives, for example, are disclosed in U.S. Pat. No. Re 24,906 (Ulrich).

In many embodiments, the release liner is structured, and the structure on the release liner can be used to create an inverse of the structure on an adhesive, resulting in a structured adhesive. For example, for every groove in the adhesive, the release liner has a corresponding ridge. The ridges would protrude from a liner reference plane, which is defined by the liner surface at the base of each ridge. The dimensions of each ridge correspond to the desired dimensions of each groove in the adhesive. For example, the groove width at the reference plane corresponds to the ridge width at the liner reference plane. In embodiments comprising a protrusion from the reference plane or from the real walls on the adhesive structured surface, the release liner will comprise a corresponding depression. The structure on the release liner can be created in a number of known ways, including embossing the liner to form a structured surface or printing a structure on the surface.

The structured adhesive layer may be created by contacting an adhesive with the structured surface of the release liner, forming an adhesive article. The adhesive may contact the structured surface by, for example, coating a composition (e.g. an adhesive composition in solution, a composition as a dispersion or a hot melt composition) or laminating an existing adhesive layer. In embodiments where the liner was coated with a release coating, the adhesive layer exists over any release coating. The structure on the release liner imparts a structure into one major surface of the adhesive layer.

The release layer may be coated on a base layer to form the release liner. Examples include papers and polymeric films, including plastics. The liner base material may be single or multiple layer. Specific examples include, polyester (for example polyethylene terephthalate), polyethylene, polypropylene (including cast and biaxially oriented polypropylene), and papers (including clay coated paper).

Generally, the structured surface of the adhesive is opposite a backing The backing can be any material, depending on the intended use of the adhesive article. For example, in embodiments where the adhesive article is used for a large format graphic (e.g. over 32 inches wide), the backing may be a material suitable for receiving an image (e.g. a vinyl or a polyolefin with an ink receptor layer opposite the adhesive layer).

In the present application, the adhesive article may be used in a method of adhering an adhesive to a substrate. In such an embodiment, the structured surface of the adhesive is applied to a bonding substrate. The structured surface of the adhesive layer deforms such that a major portion of the real walls of the first groove contacts the substrate while a major portion of the real walls of the second groove does not contact the substrate. For the purpose of the present application, a major portion of the walls has contacted the bonding substrate when more than 50% of the adhesive surface comprising the groove wall has contacted the bonding substrate.

The adhesive article can be applied to a bonding substrate using additional tools, such as temperature elevation, pressure application, and aging of the adhesive to allow flow. In some embodiments, after the major portion of the first groove is in contact with the substrate, a major portion of the walls of the second groove contacts the substrate.

In some embodiments, the adhesive article may include an additional structure on the structured surface, superimposed on the structure described herein. Examples of these additional structures can be found, for example, in U.S. Pat. No. 5,141,790. The additional structure may include adhesive or non-adhesive protrusions on the structured adhesive surface, for example projecting out of the reference plane or projecting out of the real walls of the adhesive.

### EXAMPLES

These examples are merely for illustrative purposes only and are not meant to be limiting on the scope of the appended claims. All parts, percentages, ratios, and the like in the examples and are by weight, unless noted otherwise.

The following polymers were used in the examples:

Polymer A: Non-Block polyolefin copolymer sold under the tradename Exact 5181
Polymer B: Polyolefin Block Copolymer sold under the tradename Dow Infuse 9530.05 (Density=0.887)
Polymer C: polydiorganosiloxane polyoxamide block copolymer as described in U.S. Patent Application Number 2007-0148474.
Polymer D: Polyolefin Block Copolymer sold under the tradename Dow Infuse 9500.05 (Density=0.877)
Polymer E: Polyolefin Block Copolymer sold under the tradename Dow Infuse 9507.15 (Density=0.866)
Polymer F: Low Density Polyethylene sold under the tradename Exxon 129.24

A ¾ inch Brabender lab extruder with mixing screw was used to produce films with the materials described in Table 1. The Examples were melted and forced through a 6 inch flat cast extrusion die to form a molten film. The film was then passed through a chill roll stack to cool and solidify the resins into a final, finished film. The film samples were then laminated to a 2 mil PVC film with a an acrylic adhesive, commercially available from 3M Company under the tradename 3M Scotchcal 7725-13.

TABLE 1

| Example | Composition |
|---|---|
| Comparative | 100% Polymer A |
| Example A | |
| 1 | 90% Polymer A/10% Polymer B |
| 2 | 80% Polymer A/20% Polymer B |
| 3 | 70% Polymer A/305 Polymer B |
| 4 | 50% Polymer A/50% Polymer B |
| 5 | 50% Polymer A/45% Polymer B/5% Polymer C |
| 6 | 100% Polymer B |
| 7 | 95% Polymer B/5% Polymer C |
| 8 | 95% Polymer D/5% Polymer C |
| 9 | 100% Polymer D |
| 10 | 90% Polymer A/10% Polymer D |
| 11 | 80% Polymer A/20% Polymer D |
| 12 | 70% Polymer A/30% Polymer D |
| 13 | 50% Polymer A/50% Polymer D |
| 14 | 50% Polymer A/45% Polymer D/5% Polymer C |
| 15 | 95% Polymer E/5% Polymer C |
| 16 | 100% Polymer E |
| 17 | 90% Polymer A/10% Polymer E |
| 18 | 80% Polymer A/20% Polymer E |
| 19 | 70% Polymer A/30% Polymer E |
| 20 | 50% Polymer A/50% Polymer E |
| 21 | 50% Polymer A/45% Polymer E/5% Polymer C |

The film was then tested for adhesion under two conditions 1) a five minute dwell and 2) aged in a 150 F oven for 5 days. Release tests were conducted using a 180 degree peel at 90 inches per minute on an I-Mass test unit. Results are shown in Table 2.

TABLE 2

| | 5 minute dwell peel | 5 day in oven peel |
|---|---|---|
| Example | (g/inch) | (g/inch) |
| CE A | 9.8 | 12.2 |
| 1 | 10.8 | 28.8 |
| 2 | 8.4 | 33.7 |
| 3 | 11.4 | 69.4 |
| 4 | 14.6 | 66.2 |
| 5 | 10.2 | 26.9 |
| 6 | 15.0 | 129.9 |
| 7 | 13.1 | 80.1 |
| 8 | 11.4 | 23.5 |
| 9 | 18.8 | 29.9 |
| 10 | 13.6 | 16.8 |
| 11 | 11.7 | 20.5 |
| 12 | 10.3 | 29.2 |
| 13 | 10.7 | 28.8 |
| 14 | 14.3 | 15.6 |
| 15 | 13.5 | 93.8 |
| 16 | 16.2 | 12.0 |
| 17 | 15.8 | 19.4 |
| 18 | 10.5 | 19.2 |
| 19 | 11.4 | 16.7 |
| 20 | 12.0 | 16.1 |
| 21 | 8.2 | 11.8 |

A ¾ inch Brabender lab extruder with mixing screw was used to produce films with the materials described in Table 3. The Examples were melted and forced through a 6 inch flat cast extrusion die to form a molten film. The film was then passed through a chill roll stack to cool and solidify the resins into a final, finished film. The film samples were then laminated to an adhesive file with a 2.5 mil thick polyethylene backing and an adhesive layer (0.8 mil thick) comprising 15.45% butyl acrylate, 64.25% isooctyl acrylate, 16.8% octadecyl acrylate, 2% acrylic acid and 1.5% substituted benzophenone. The adhesive was crosslinked with UV light.

| Example | Composition |
|---|---|
| Comparative | 100% Polymer A |
| Example B | |
| 22 | 50% Polymer A/50% Polymer B |
| 23 | 50% Polymer A/45% Polymer B/5% Polymer C |
| 24 | 100% Polymer B |
| 25 | 95% Polymer B/5% Polymer C |
| 26 | 95% Polymer D/5% Polymer C |
| 27 | 100% Polymer D |
| 28 | 50% Polymer A/50% Polymer D |
| 29 | 50% Polymer A/45% Polymer D/5% Polymer C |
| 30 | 95% Polymer E/5% Polymer C |
| 31 | 100% Polymer E |
| 32 | 50% Polymer A/50% Polymer E |
| 33 | 50% Polymer A/45% Polymer E/5% Polymer C |

The film was then tested for adhesion under three conditions 1) a less than 5 minute dwell at room temperature (25 C) and 2) a 10 day dwell at 120 F and 3) a 2 week dwell at 90 F and 90% humidity. Results are shown in Table 4.

TABLE 4

| | Room Temp | 120 F. | 90 F./90% humidity |
|---|---|---|---|
| Example | (g/inch) | (g/inch) | (g/inch) |
| Comp. Ex. B | 38.5 | 34.2 | 34.5 |
| 22 | 17.9 | 8.8 | 19.6 |
| 23 | 16.7 | 5.3 | 14.2 |
| 24 | 10.6 | 3.4 | 6.0 |
| 25 | 10.3 | 5.3 | 9.4 |
| 26 | 7.7 | 2.7 | 3.0 |
| 27 | 4.3 | 2.6 | 3.4 |
| 28 | 4.0 | 2.8 | 3.1 |
| 29 | 2.7 | 1.5 | 2.9 |
| 30 | 4.6 | 2.4 | 1.7 |
| 31 | 4.0 | 2.2 | 1.3 |
| 32 | 3.0 | 1.8 | 3.0 |
| 33 | 3.7 | 2.1 | 1.1 |

Comparative Examples C and D were made as in Comparative Example A with the compositions detailed in Table 5

TABLE 5

| Example | Composition |
|---|---|
| Comparative Example C | 60% Polymer A/40% Polymer F |
| Comparative Example D | 80% Polymer A/20% Polymer F |

Comparative Examples C and D were aged at room temperature (25 C) for 24 hours. Release tests were conducted using a 180 degree peel at 90 inches per minute on an I-Mass test unit. Results are shown in Table 6.

TABLE 6

| Example | Room Temp/24 hours (g/inch) |
|---|---|
| Comparative Example C | 58 |
| Comparative Example D | 47 |

### Embossing Examples

A release liner was made with a release surface of a Polyolefin Block Copolymer sold under the tradename Dow Infuse 9100 (Density=0.877 gm/cm³). The liner was produced using a 3 layer blown film coextrusion line—the outside layer of the bubble was the Polyolefin Block Copolymer containing 3% Polyfil ABC5000 antiblock compound;

the core layer contained an 80/20 blend of Polypropylene resin (tradename Phillips Sumika HHC007) and linear low density resin (tradename Chevron D-143); the inside layer of the bubble contained the 80/20 blend of PP/LLDPE and 4% Polyfil ABC5000 antiblock concentrate. The resulting release liner was embossed to create a pattern in the release surface. The release surface was then coated with a pressure sensitive adhesive. The adhesive was then removed from the release liner. There was minimal degradation of the pattern on the release liner. The adhesive surface also retained the inverse structure of the release liner.

A comparative release liner was made with a release surface of a Non-Block polyolefin copolymer sold under the tradename Exact 8201. The liner was produced using a 3 layer blown film coextrusion line—the outside layer of the bubble was the Non-Block polyolefin copolymer containing 3% Polyfil ABC5000 antiblock compound; the core layer contained an 80/20 blend of Polypropylene resin (tradename Phillips Sumika HHC007) and linear low density resin (tradename Chevron D-143); the inside layer of the bubble contained the 80/20 blend of PP/LLDPE and 4% Polyfil ABC5000 antiblock concentrate. The resulting release liner was embossed to create a pattern in the release surface. The release surface was then coated with a pressure sensitive adhesive. The adhesive was then removed from the release liner. The patter on the release liner degraded. Additionally, the adhesive surface was degraded because of the degradation of the release liner structure.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. An adhesive article comprising:
a pressure sensitive adhesive layer
a release layer in contact with the pressure sensitive adhesive layer, the release layer comprising a polyolefin block copolymer.

2. The adhesive article of claim 1 wherein the polyolefin block copolymer has a density of no greater than 0.9 g/cc.

3. The adhesive article of claim 1 wherein the polyolefin block copolymer has a density of no greater than 0.89 g/cc.

4. The adhesive article of claim 1 wherein the polyolefin block copolymer has a density of greater than 0.85 g/cc.

5. The adhesive article of claim 1 wherein the polyolefin block copolymer has a density of greater than 0.86 g/cc.

6. The adhesive article of claim 1 wherein the release layer further comprises a polydiorganosiloxane polyoxamide linear block copolymer.

7. The adhesive article of claim 1 wherein the release layer further comprises a second polyolefin polymer having a density of no greater than 0.9.

8. The adhesive article of claim 1 wherein the release layer comprises at least 10 percent by weight of the polyolefin block copolymer.

9. The adhesive article of claim 1 wherein the release layer comprises at least 20 percent by weight of the polyolefin block copolymer.

10. The adhesive article of claim 1 wherein the release layer comprises at least 30 percent by weight of the polyolefin block copolymer.

11. The adhesive article of claim 1 wherein the release layer comprises at least 50 percent by weight of the polyolefin block copolymer.

12. The adhesive article of claim 1 wherein the interface between the adhesive layer and the release layer is a structured interface.

13. The adhesive article of claim 1 wherein the adhesive is an acrylic adhesive.

14. The adhesive article of claim 13 wherein the adhesive comprises octedecyl aceylate.

15. The adhesive article of claim 1 wherein the polyolefin block copolymer has a melting point of about 120° C.

16. A method of manufacturing a release liner comprising
providing a lease liner having a polyolefin block copolymer on a first surface, and structuring the first surface of the release liner.
